(19) United States
(12) Patent Application Publication
(10) Pub. No.: US 2010/0182104 A1
(43) Pub. Date: Jul. 22, 2010

(54) STRIPLINE FILTER

(75) Inventors: Yasunori Takei, Komatsu-shi (JP); Tatsuya Tsujiguchi, Ishikawa-gun (JP); Nobuyoshi Honda, Kanazawa-shi (JP)

Correspondence Address: DICKSTEIN SHAPIRO LLP, 1633 Broadway, NEW YORK, NY, 10019, US

(73) Assignee: Murata Manufacturing Co., Ltd.

(21) Appl. No.: 12/752,433

(22) Filed: Apr. 1, 2010

Related U.S. Application Data
(63) Continuation of application No. PCT/JP2009/006240, filed on Jul. 8, 2009.

(30) Foreign Application Priority Data
Jul. 11, 2008 (JP) 2008-180995

(51) Int. Cl. H01P 1/203

(52) U.S. Cl. 333/204

(57) ABSTRACT

A stripline filter includes a ground electrode, input and output electrodes, top-surface resonant lines, side-surface resonant lines, side-surface line portions, connection electrode portions, and top-surface line portions. The ground electrode is provided on the bottom side of a dielectric substrate. The input and output electrodes are provided on the bottom surface of the substrate so as to be separate from the ground electrode. The top-surface resonant lines are provided on the top surface of the substrate. The side-surface line portions, the connection electrode portions, and the top-surface line portions connect two of the top-surface resonant lines to the input and output electrodes. The line width of the two top-surface resonant lines is smaller than the line width of the remainder of the top-surface resonant lines.

### CROSS REFERENCE TO RELATED APPLICATIONS

The present application is a continuation of International Application No. PCT/JP2009/062420, filed Jul. 8, 2009, and claims priority to Japanese Patent Application No. JP2008-180995, filed Jul. 11, 2008, the entire contents of each of these applications being incorporated herein by reference in their entirety.

### FIELD OF THE INVENTION

The present invention relates to stripline filters in which striplines are provided on dielectric substrates.

### BACKGROUND OF THE INVENTION

Wide-band filter characteristics are required for filters used in communication systems using wide band widths at high frequencies such as UWB (ultra wide band) communication. A band width ratio of a filter depends on the strength of electromagnetic field coupling between resonator and the strength of external coupling. Thus, a stripline filter having a wide-band filter characteristic in which individual resonator are interdigitally coupled to each other may be used (see, for example, Patent Document 1). In the stripline filter, resonant lines constituting the resonators at input and output stages and input and output electrodes are directly connected by electrodes and thus tap-coupled, which realizes strong external coupling.

Patent Document 1 illustrates and describes the interdigital coupling of an open-circuit terminal and short-circuit terminals of alternatively arranged three-stage resonant line electrodes, and tap coupling by direct connection of resonant line electrodes at input and output stages to input and output electrodes.

[Patent Document 1] Japanese Unexamined Patent Application Publication No. H6-216605

A band width ratio of a filter is affected by electromagnetic field coupling between resonators constituting the filter. Thus, conventionally, when the band width ratio of a filter is adjusted to a desired one, electromagnetic field coupling is controlled by adjusting an interval between individual resonators. In this case, since an interval between resonators serves as a setting variable of electromagnetic field coupling, the outer dimensions of the filter may be restricted. Therefore, it may not be possible to satisfy an outer dimensional requirement such as size reduction while realizing a required band width ratio of the filter.

Accordingly, it may be proposed that a desired band width ratio of a filter is set by adjusting the strength of external coupling. The band width ratio of a filter increases with increasing strength of external coupling, and the strength of external coupling increases with increasing characteristic impedance of resonators at input and output stages. Therefore, it may be proposed that characteristic impedance is controlled to satisfy requirements of band width ratio. However, adjustment of characteristic impedance may change filter characteristics such as a transmission characteristic and a reflection characteristic, which may result in undesired filter characteristics. For example, an increase in characteristic impedance by decreasing line widths of individual resonant lines may increase the resistances of the resonant lines and an increase in insertion loss of the filter. As a result, a satisfactory transmission characteristic may not be achieved.

### SUMMARY OF THE INVENTION

Thus, an object of the present invention is to provide a stripline filter which can increases the strength of external coupling while easing restrictions on outer dimensions and suppressing degradation of filter characteristics.

According to the present invention, a stripline filter having three or more stage resonators including resonators at input and output stages and a resonator at an intermediate stage includes a ground electrode, input and output electrodes, an intermediate-stage resonant line, input- and output-stage resonant lines, and connection electrodes. The ground electrode is provided only on a bottom surface of a dielectric substrate having the shape of a rectangular plate. The input and output electrodes are provided on the bottom surface of the dielectric substrate so as to be separate from the ground electrode. The intermediate-stage resonant line is provided on the top surface of the dielectric substrate and constitutes the resonator at the intermediate stage. The input- and output-stage resonant lines are provided on the top surface of the dielectric substrate and have a line width smaller than the line width of the intermediate-stage resonant line. The input- and output-stage resonant lines constitute the resonators of the input and output stages. The connection electrodes connect the input- and output-stage resonant lines to the input and output electrodes.

Restrictions on the outer dimensions of the filter is more eased with decreasing line width of the input- and output-stage resonant lines, which permits, for example, size reduction of the filter. Besides, by decreasing the line width of the input- and output-stage resonant lines, the characteristic impedance of the input- and output-stage resonant lines is increased and thus the strength of external coupling is increased, compared with the case where the line width of the input- and output-stage resonant lines is equal to the line width of the intermediate-stage resonant line. In this case, the resistance of the input- and output-stage resonant lines is increased, resulting in an increase in insertion loss of the filter. However, the influence of the line width with respect to filter insertion loss is relatively significant on the resonator at the intermediate stage. Therefore, an increase in filter insertion loss can be suppressed by increasing the line width of the line constituting the intermediate-stage resonator.

It is preferable that an interval between an input- or output-stage resonant line and a resonant line adjacent the input- or output-stage resonant line be wider than an interval between other resonant lines. In this configuration, the strength of electromagnetic field coupling between the resonators constituted by the input- and output-stage resonant line and the adjacent resonators is decreased, and thus the filter is biased so as to have a decreased band width ratio. Accordingly, it is possible to ease restrictions on the outer dimensions of the filter while negating effects produced by an increase in the filter band width due to an increase in external coupling. That is, it is possible to increase design variables to obtain an increased degree of design freedom in order to realize an arbitrary frequency characteristic which is similar to one in a conventional technique, for example.

The connection electrodes include top-surface line portions provided on the top surface of the dielectric substrate and side-surface line portions each provided on a side surface of the dielectric substrate so as to travel through the center of the side surface. It is preferable that the line width of the top-surface line portions be smaller than the line width of the side-surface line portions. This configuration can prevent mounting failure by self-alignment effects in mounting of a SMD chip by molten soldering. Besides, the configuration makes it possible to ease restrictions on the outer dimensions of the filter while increasing external coupling.

It is preferable that the three or more stage resonators be interdigitally coupled to each other. With this configuration, electromagnetic field coupling between the resonators is large, and thus a wide-band frequency characteristic suitable for UWB communication or the like can be obtained.

The top surface of the dielectric substrate may be exposed or provided thereon with a laminated dielectric substrate or a laminated glass layer.

According to the present invention, strong external coupling can be achieved by decreasing the line width of the input-stage resonant line while restrictions on outer dimensions are eased and while degradation of filer characteristics is suppressed.

### BRIEF DESCRIPTION OF THE DRAWINGS

FIG. 1 is an exploded perspective view of the top surface side of a stripline filter according to a first embodiment.

FIG. 2 is a perspective view of the bottom surface side of the stripline filter.

FIGS. 3(A) and 3(B) illustrate a relationship between the line width of input- and output-stage resonant lines provided in the stripline filter and external coupling.

FIG. 4(A) illustrates a configuration example of a stripline filter according to the present configuration example; FIG. 4(B) illustrates a comparative example of a stripline filter; and FIG. 4(C) illustrates filter characteristics of the stripline filter according to the present configuration example and the stripline filter according to the comparative example.

FIG. 5 is a top view of a dielectric substrate of a stripline filter according to a second embodiment.

### DETAILED DESCRIPTION OF THE INVENTION

In the following, an example of a configuration of a stripline filter according to a first embodiment will be described.

The stripline filter described herein is a band pass filter. The filter is used in UWB (Ultra Wide Band) communication operating at high frequencies higher than 4 GHz.

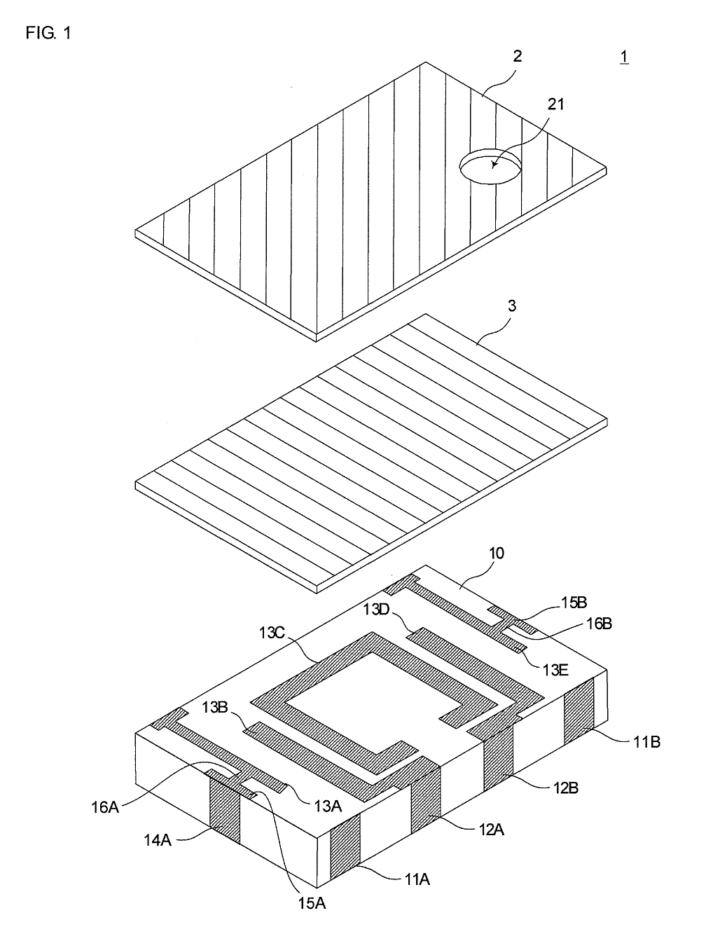

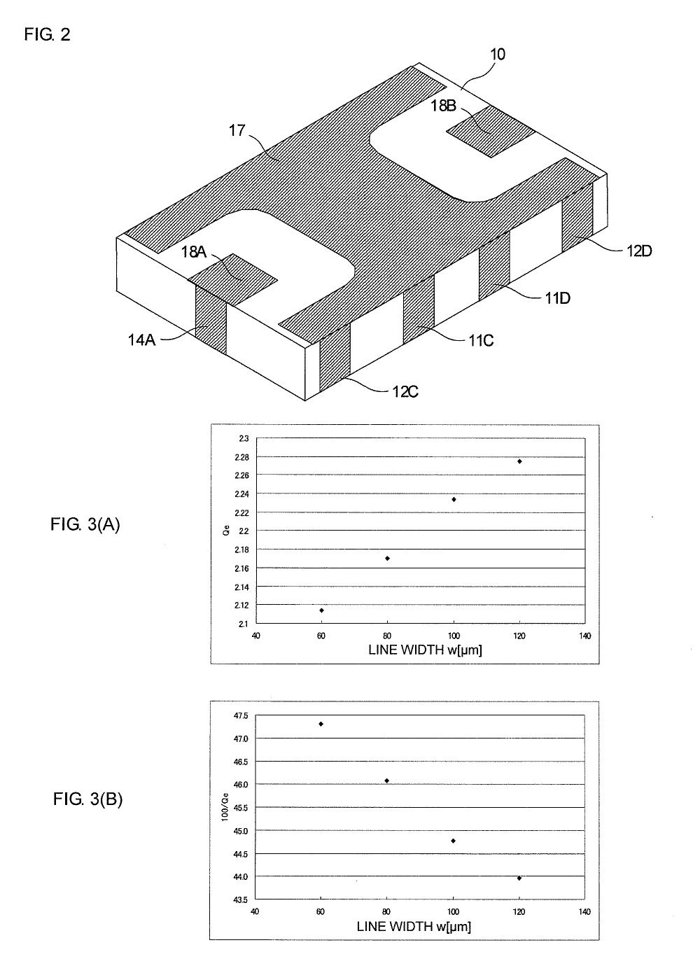

FIG. 1 is an exploded perspective view of the top surface side of the stripline filter. FIG. 2 is a perspective vide of the bottom surface side of the stripline filter.

A stripline filter 1 has a dielectric substrate 10 having the shape of a rectangular plate and laminated glass layers 2 and 3. The laminated glass layers 2 and 3 each have a thickness of about 15 μl. The laminated glass layers 2 and 3 are laminated on the dielectric substrate 10 and serve for mechanical protection of the stripline filter 1 and improvement of environmental resistance. The laminated glass layer 2 has a hole 21 serving as a mark which enables visual recognition of the orientation of the stripline filter 1. The laminated glass layers 2 and 3 are not essential components, and it is possible that the laminated glass layers 2 and 3 are not provided and the top surface of the dielectric substrate 10 is exposed. It is also possible that another dielectric substrate is laminated on the top surface of the dielectric substrate 10 and a top-surface ground electrode is provided on the top surface of the substrate.

The dielectric substrate 10 is a compact rectangular parallelepiped ceramic-sintered substrate composed of titanium oxide or the like and has a relative dielectric constant of about 111. The composition and dimensions of the substrate 10 may be appropriately set in view of frequency characteristics, specifications, and the like.

Top-surface resonant lines 13A to 13E, top-surface line portions 16A and 16B, and connection electrode portions 15A and 15B are formed on the top surface of the substrate 10. These electrode patterns are composed of silver electrodes having a thickness of about 5 μm or larger. The electrode patterns are formed by applying photosensitive silver paste onto the substrate 10, forming patterns by photolithography processes, and performing firing. These electrodes serve as photosensitive silver electrodes, so that a stripline filter having increased shape precision and thus usable in UWB communication can be achieved.

Side-surface resonant lines 12A and 12B and dummy electrodes 11A and 11B are formed on the right front surface (right side surface) of the substrate 10 in FIG. 1. As illustrated in FIG. 2, side-surface resonant lines 12C and 12D and dummy electrodes 11C and 11D are formed on the left back surface (left side surface) opposed to the right front surface (right side surface) of the substrate 10. These electrode patterns are composed of silver electrodes having a thickness of about 12 μm or larger. The electrode patterns are formed by applying non-photosensitive silver paste onto the substrate 10 using a screen mask or a metal mask and perform firing. The shapes of the electrode patterns on the right front surface (right side surface) and the electrode patterns on the left back surface (left side surface) of the substrate 10 are configured to be congruent, so that it is not necessary to control the orientation of the substrate 10 during the formation process of the electrode patterns. However, the dummy electrodes 11A to 11D are not essential components and can be omitted. The electrode thickness of the side-surface electrode patterns is set to be larger than the electrode thickness of the top-surface electrode pattern, so that a current at a ground terminal portion, where a current is generally concentrated, is dispersed and thus conductor loss is reduced.

A side-surface line portion 14A is formed on the left front surface (front surface) of the substrate 10 in FIG. 1. A side-surface line portion 14B (not shown) is formed on the right back surface (back surface) opposed to the left front surface (front surface) of the substrate 10. These electrode patterns are silver electrodes having a thickness of about 12 μm or larger and are formed by applying non-sensitive silver paste onto the substrate 10 using a screen mask or a metal mask and perform firing. The electrode pattern on the left front surface (front surface) and the electrode pattern on the right back surface (back surface) of the substrate 10 each extend through the center of the corresponding surface and are configured to be congruent. With this configuration, it is not necessary to control the orientation of the substrate 10 during the formation process of the electrode patterns. In addition, an appropriate mount position can be achieved by solder self-alignment effects in SMD chip mounting.

The bottom surface of the substrate 10 serves as a mounting surface of the stripline filter 1 and has formed thereon a ground electrode 17 and input and output electrodes 18A and 18B that are separated from each other. The input and output electrodes 18A and 18B are formed to be separated from the ground electrode 17. The input and output electrodes 18A and 18 are connected to high-frequency signal input and output terminals when the stripline filter 1 is mounted on a mounting substrate. The ground electrode 17 serves as the ground surface of the resonators and is connected to a ground electrode of the mounting substrate.

The bottom electrode patterns are composed of silver electrodes having a thickness of about 12 μm or larger and are formed by applying non-sensitive silver paste onto the substrate 10 using a screen mask or a metal mask and perform firing. The input and output electrodes 18A and 18B are provided at positions adjacent the boundary of the left front surface (front surface) and the bottom surface and the boundary of the right back surface (back surface) and the bottom surface. The width of the input and the output electrodes 18A and 18B at the boundaries is set to be larger than the width of the side-surface line portions 14A and 14B. This arrangement improves the connectivity to the side-surface line portions 14A and 14B and improves the insulation performance between the side-surface line portions 14A and 14B and the ground electrode 17.

Meanwhile, on the top surface of the dielectric substrate 10, the top-surface resonant lines 13A and 13E are connected to the side-surface resonant lines 12C and 12D at the boundary of the left back surface (left side surface) and the top surface of the substrate 10 and are also connected to the ground electrode 17 on the bottom surface via the side-surface resonant lines 12C and 12. The top-surface resonant lines 13A and 13E extend from the boundary to the right front surface (right side surface) and the ends thereof are open-circuited. The top-surface resonant lines 13B and 13D are connected to the side-surface resonant lines 12A and 12B at the boundary of the right front surface (right side surface) and the top surface of the substrate 10 and are connected to the ground electrode 17 on the bottom surface via the side-surface resonant lines 12A and 12B. In addition, the top-surface resonant lines 13B and 13D are bended at the boundary and extend to the left back surface (left side surface), and the ends thereof are open-circuited. The top-surface resonant line 13C is a C-shaped electrode with the side of the right front surface (right side surface) open and is disposed at the center of the substrate 10. The both ends of the top-surface resonant line 13C are open-circuited. These top-surface resonant lines 13A to 13E are opposed to the ground electrode 17 on the bottom surface and are interdigitally coupled to each other, thereby constituting five-stage resonators.

The top-surface resonant line 13A constituting the first-stage resonator and the top-surface resonant line 13E constituting the fifth-stage resonator are input- and output-stage resonant lines of the present invention which form resonators at input and output stages. The top-surface resonant lines 13B to 13D constituting the second to fourth stage resonators are intermediate-stage resonant lines of the present invention which form resonators at intermediate stages.

The top-surface resonant lines 13A and 13E are connected to the input and output electrodes 18A and 18B via the top-surface line portions 16A and 16B, the connection electrode portions 15A and 15B, and the side-surface line portions 14A and 14B. The top-surface line portions 16A and 16B are connected between the top-surface resonant lines 13A and 13E and the connection electrode portions 15A and 15B. The connection electrode portions 15A and 15B are formed at top surface edge portions of the dielectric substrate 10 and are connected to the side-surface line portions 14A and 14B and the top-surface line portions 16A and 16B. The side-surface line portions 14A and 14B are connected to the input and output electrodes 18A and 18B. Thus, the top-surface line portions 16A and 16B, the connection electrode portions 15A and 15B, and the side-surface line portions 14A and 148 constitute tap electrodes through which the resonators constituted by the top-surface resonant lines 13A and 13E and the input and output electrodes 18A and 18B are directly connected and thus tap-coupled.

The width of the connection electrode portions 15A and 15B is herein set to be larger than the sum of a representative value of errors in electrode formation of the side-surface line portions 14A and 14B and the line width of the side-surface line portions 14A and 14B. This arrangement ensures connection of the side-surface line portions 14A and 14B to the connection electrode portions 15A and 15B throughout the entire length of the side-surface line portions 14A and 14B. In addition, the line width of the top-surface line portions 16A and 16B is set to be smaller than the width of the side-surface line portions 14A and 14B and the width of the connection line portions 15A and 15B. Thus, capacitance generated between the top-surface line portions 16A and 16B and the ground electrode 17 is decreased so that the strength of external coupling is increased.

The above configuration realizes strong electromagnetic field coupling by the interdigital coupling as well as strong external coupling by the tap coupling and allows the stripline filter 1 to be used in wide band applications suitable for UWB communication or the like.

The line width of each of the top-surface resonant lines 13A and 13E is smaller than the line width of the top-surface resonant lines 13B to 13D. By setting a small line width of the top-surface resonant lines 13A and 13E that constitute the resonators at the input and output stages, a high characteristic impedance of the top-surface resonant lines 13A and 13E is obtained. The external Q (Qₑ) is proportional to the reciprocal of the characteristic impedance of the input- and output-stage resonators, and the strength of external coupling is proportional to the reciprocal of the external Q (Qₑ). Accordingly, by employing the present configuration, an increased characteristic impedance of the top-surface resonant lines 13A and 13E can be obtained. As a result, the strength of external coupling is increased, and the filter is biased to have an increased band width ratio. FIGS. 3(A) and 3(B) illustrate calculation results of changes in external Q (Qₑ) and changes in external coupling in accordance with changes in the line width of the top-surface resonant lines 13A and 13E. In this calculation, the line width of the top-surface resonant lines 13B to 13D is set to 120 μm. As can be seen from the calculation results, a smaller line width of each of the top-surface resonant lines 13A and 13E results in a smaller external Q (Qₑ) and stronger external coupling.

However, the band width ratio of the stripline filter 1 is affected by the strength of electromagnetic field coupling between the resonators as well as the strength of external coupling. In the present embodiment, there is a wide interval between the top-surface resonant lines 13A and 13E and the top-surface resonant lines 13B and 13D. Therefore, the strength of electromagnetic field coupling between the resonators is small. As a result of the decrease in electromagnetic field coupling, the filter is biased to have a decreased band width ratio. Therefore, an increase in the band width obtained by the increase in reciprocal of the external Q (Qₑ). Accordingly, by employing the present configuration, an increased characteristic impedance of the top-surface resonant lines 13A and 13E can be obtained. As a result, the strength of external coupling is increased, and the filter is biased to have an increased band width ratio. FIGS. 3(A) and 3(B) illustrate calculation results of changes in external Q (Qₑ) and changes in external coupling in accordance with changes in the line width of the top-surface resonant lines 13A and 13E. In this calculation, the line width of the top-surface resonant lines 13B to 13D is set to 120 μm. As can be seen from the calculation results, a smaller line width of each of the top-surface resonant lines 13A and 13E results in a smaller external Q (Qₑ) and stronger external coupling.

However, the band width ratio of the stripline filter 1 is affected by the strength of electromagnetic field coupling between the resonators as well as the strength of external coupling. In the present embodiment, there is a wide interval between the top-surface resonant lines 13A and 13E and the top-surface resonant lines 13B and 13D. Therefore, the strength of electromagnetic field coupling between the resonators is small. As a result of the decrease in electromagnetic field coupling, the filter is biased to have a decreased band width ratio. Therefore, an increase in the band width obtained by the increase in external coupling is negated by the increase in electromagnetic field coupling. In the stripline filter 1, restrictions on the outer dimensions are eased while a band width ratio which is to be obtained when the top-surface resonant lines 13A to 13E have the same line width is maintained.

Further, a decrease in line width of a top-surface resonant line results in an increase in resistance component of the top-surface resonant line and a decrease in unloaded Q (Q₀), which increases insertion loss of the filter. Therefore, also in the present configuration, the filter may be biased such that an increase in insertion loss is increased. However, since the line width of the top-surface resonant lines 13B to 13D is large, the decrease in unloaded Q (Q₀) is suppressed to an increase equivalent to a resistance by the top-surface resonant lines 13A and 13E. Thus, the increase in insertion loss can be suppressed. In addition, the influence of a line width with respect to filter insertion loss is more significant on a resonator at the center than on resonators at input and output stages. Therefore, filter insertion loss can be suppressed by increasing the line width of a line constituting a resonator at the intermediate stage.

In the following, a filter characteristic of the stripline filter 1 according to the present embodiment will be described on the basis of simulation results.

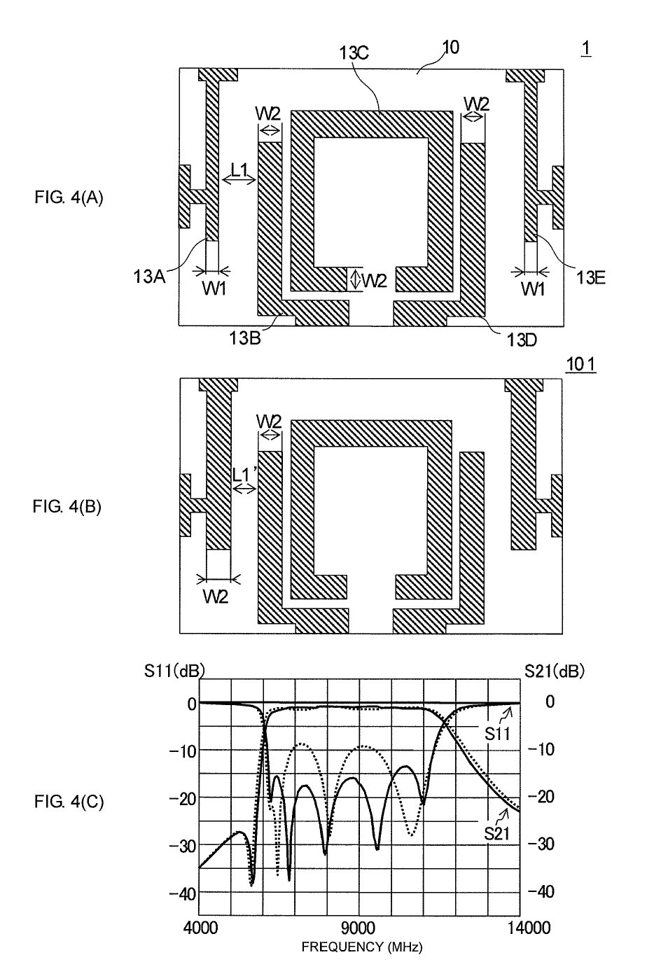

FIG. 4(A) illustrates a configuration example of a stripline filter according to the present embodiment. FIG. 4(B) illustrates a configuration example of a stripline filter provided for comparison. FIG. 4(C) illustrates filter characteristics of the stripline filter according to the present configuration example and the stripline filter according to the comparative example. In the filter characteristics, the solid line indicates the present configuration example and the dotted line indicates the comparative example.

As illustrated in FIG. 4(A), in the stripline filter 1 in the present configuration example, the line width of each of the top-surface resonant lines 13A and 13E is W1, and the line width of each of the top-surface resonant lines 13B to 13D is W2. The line width W1 is smaller than the line width W2. The top-surface resonant lines 13A and 13E and the top-surface resonant lines 13B and 13D are disposed with an interval of L1.

As illustrated in FIG. 4(B), in a stripline filter 101 of the comparative example, top-surface resonant lines 13A to 13E have an equal width of W2. The top-surface resonant lines 13A and 13E and the top-surface resonant lines 13B and 13D are disposed with an interval of L1′. The sum of the interval L1' and the line width W2 in the comparative example is set to be equal to the sum of the interval L1 and the line width W1 in the present configuration example.

When the present configuration example and the comparative example are compared with respect to transmission characteristic (S21) in FIG. 4(C), it can be seen that there is little difference in 3-dB band width ratio. This may be considered as a result of offset between the change in external coupling and the change in electromagnetic field coupling.

In addition, there is little difference in insertion loss at the 3-dB band width ratio in the transmission characteristics (S21). This may be because the insertion loss has hardly been increased since, in the present configuration example, the line width of the top-surface resonant lines 13B to 13D was not changed while the line width of the top-surface resonant lines 13A and 13E at the input and output stages was decreased. It can be seen that, in the comparative example, the insertion loss is large at certain frequencies. This may be a result of an increase in insertion loss in the comparative example due to deterioration of impedance matching balance which may be caused by a change from the present configuration example, in which impedance matching was being maintained, to the configuration of the comparative example.

When the present configuration example and the comparative example are compared with respect to reflection characteristic (S11), it can be seen that the present configuration example has a smaller amount of reflection and is thus more satisfactory than the comparative example. This may be a result of an increase in insertion loss in the comparative example due to deterioration of impedance matching balance which may be caused by a change from the present configuration example, in which impedance matching was being maintained, to the configuration of the comparative example.

As can be seen from the above simulation results, it is possible to suppress degradation of filter characteristics when only the line width of the top-surface resonant lines at the input and output stages is decreased, as in the case of the present configuration example.

In the following, a stripline filter according to a second embodiment of the present invention will be described.

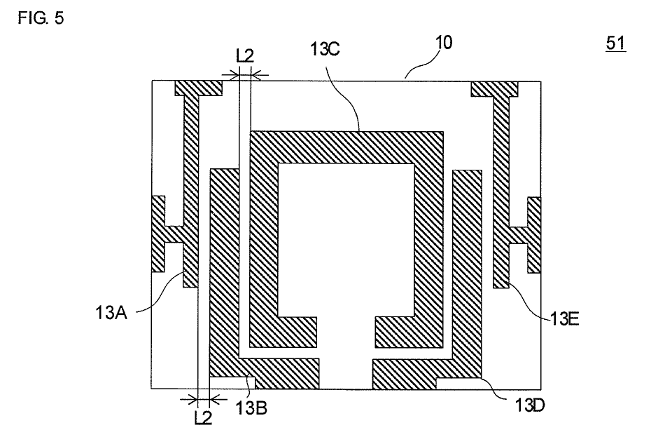

FIG. 5 is a top view of a dielectric substrate of a stripline filter 51 according to the present embodiment. In the stripline filter 51 of the present embodiment, an interval between a top-surface resonant line 13A (13E) and a top-surface resonant line 13B (13D) is equal to an interval L2 between the top-surface resonant lines 13B or 13D and 13C. In this respect, the stripline filter 51 is different from the stripline filter 1 according to the first embodiment.

In this configuration, external coupling is strong because of the small line width of the top-surface resonant line 13A (13E), and electromagnetic field coupling between resonators is also strong because of the short interval L2 between the top-surface resonant line 13A (13E) and the top-surface resonant line 13B (13D). Therefore, the stripline filter 51 has a larger band width ratio than the stripline filter 1 according to the first embodiment. In addition, the stripline filter 51 permits a significant reduction of outer dimensions because of the small line width of the top-surface resonant lines 13A and 13E and the narrow interval between the top-surface resonant line 13A (13E) and the top-surface resonant line 13B (13D).

As described above, according to the present invention, it is possible to increase the strength of external coupling while easing restrictions on outer dimensions and suppressing degradation of filter characteristics, by decreasing the line width of the top-surface resonant lines at the input and output stages.

The positions and forms of the top-surface resonant lines and extraction electrodes in the above embodiments are based on product specifications, and any position and form may be adopted in accordance with the product specifications. The present invention may be applied to a configuration other than the above configuration, and may be employed in various pattern forms of filters. Further, another configuration (high frequency circuit) is provided in this filter.

### REFERENCE NUMERALS

1, 51 stripline filter
2 and 3 laminated glass layers
dielectric substrate
11A to 11D dummy electrodes
12A to 12D side-surface resonant lines
13A to 13E top-surface resonant lines
14A and 14B side-surface line portions 15A and 15B connection electrode portions
16A and 16B top-surface line portions
ground electrode
18A and 18B input and output electrodes
hole

1. A stripline filter having three or more stage resonators including input and output stage resonators and an intermediate stage resonator, the stripline filter comprising:
a dielectric substrate having opposed top and bottom surfaces;
a ground electrode provided on the bottom surface of the dielectric substrate;
input and output electrodes provided on the bottom surface of the dielectric substrate and separated from the ground electrode;
an intermediate-stage resonant line provided on the top surface of the dielectric substrate, the intermediate-stage resonant line comprising the intermediate stage resonator;
input- and output-stage resonant lines provided on the top surface of the dielectric substrate, the input- and output-state resonator lines having a line width smaller than a line width of the intermediate-stage resonant line; and
connection electrodes configured to connect the input- and output-stage resonant lines to the input and output electrodes.

2. The stripline filter of claim 1,
wherein a first interval between the input- and output-stage resonant lines and resonant lines adjacent the input- and output-stage resonant lines is wider than a second interval between other resonant lines.

3. The stripline filter of claim 1,
wherein the connection electrodes include:
top-surface line portions provided on the top surface of the dielectric substrate; and
side-surface line portions provided on a side surface of the dielectric substrate so as to span through the center of the side surface,
wherein a line width of the top-surface line portions is smaller than a line width of the side-surface line portions.

4. The stripline filter of claim 1, wherein the connection electrodes include:
side-surface line portions provided on a side surface of the dielectric substrate so as to span through the center of the side surface,
wherein a line width of the side-surface line portions is smaller than a width of the input and output electrodes.

5. The stripline filter of claim 1,
wherein the three or more stage resonators are interdigitally coupled to each other.

6. The stripline filter of claim 1, further comprising a laminated layer on the top surface of the dielectric substrate.

7. The stripline filter of claim 6, wherein the laminated layer is a laminated glass layer laminated on the top surface of the dielectric substrate.

8. The stripline filter of claim 1, wherein a first interval between the input- and output-stage resonant lines and resonant lines adjacent the input- and output-stage resonant lines is substantially equal to a second interval between other resonant lines.
